(19) United States
(12) Patent Application Publication
(10) Pub. No.: US 2024/0265297 A1
(43) Pub. Date: Aug. 8, 2024

(54) METHOD AND A SYSTEM FOR GENERATING A MACHINE LEARNING MODEL FOR REDUCING A LOCATION ERROR OF READINGS OF ROAD SIGNS SENSED BY CONNECTED VEHICLES

(71) Applicant: OTONOMO TECHNOLOGIES LTD., Herzeliya Pituach (IL)

(72) Inventor: Itamar LANDSMAN, Petah Tikva (IL)

(73) Assignee: OTONOMO TECHNOLOGIES LTD., Herzeliya Pituach (IL)

(21) Appl. No.: 18/165,532

(22) Filed: Feb. 7, 2023

(51) Int. Cl. G06N 20/00

(52) U.S. Cl. CPC G06N 20/00

(57) ABSTRACT

A method and a system for generating a machine learning model for reducing a location error of readings of road signs sensed by connected vehicles, said method comprising: obtaining an incoming stream of readings of road signs captured by connected vehicles traveling along roads, wherein each reading contains a location of a road sign and road sign metadata associated therewith; applying a clustering algorithm to group together readings associated with a common road sign in separate groups; comparing the locations of each group to respective tagged road-signs dataset associated with a correct location, to yield a correction vector for each cluster; and training a machine learning model to correct the location of the readings in each group by learning the correction vectors.

### FIELD OF THE INVENTION

The present invention relates generally to a computerized automotive marketplace, and more particularly, to processing automotive data of connected vehicles on same.

### BACKGROUND OF THE INVENTION

Prior to the background of the invention being set forth, it may be helpful to provide definitions of certain terms that will be used hereinafter.

The term “connected vehicle” or “connected car” as used herein is defined as a car or any other motor vehicle such as a drone or an aerial vehicle that is equipped with any form of wireless network connectivity enabling it to provide and collect data from the wireless network. The data originated from and related to connected vehicles and their parts is referred herein collectively as “automotive data”.

The term “data marketplace” or “data market” as used herein is defined as an online platform preferably implemented on a cloud that enables a plurality of users (e.g. subscribers or consumers) to access and consume data originated by various data sources (e.g. data providers). Data marketplaces typically offer various types of data for different markets and from different sources. Common types of data consumers include business intelligence, financial institutions, demographics, research and market data. Data types can be mixed and structured in a variety of ways. Data providers may offer data in specific formats for individual clients.

Data consumed in these marketplaces is used by businesses of all kinds, fleets, business and safety applications and many types of analysts. Data marketplaces have proliferated with the growth of big data, as the amount of data collected by municipalities and smart cities, businesses, websites, and services has increased, and all that data has become increasingly recognized as an asset.

The road-sign data that is produced by connected-vehicles, proves to be noisy and inaccurate. It would be desirable to improve the accuracy of the data that is obtained from road signs and captured via the connected vehicles.

### SUMMARY OF THE INVENTION

Embodiments of the present invention provide a method and a system for generating a machine learning model for reducing a location error of readings of road signs sensed by connected vehicles. The method may include the following steps: obtaining an incoming stream of readings of road signs captured by connected vehicles traveling along roads, wherein each reading contains a location of a road sign and road sign metadata associated therewith; using a clustering algorithm to cluster together readings associated with a common road sign in respective; comparing the locations of each group to respective tagged road-signs dataset having a correct location, to yield a correction vector; and training a machine learning model to correct the location of the readings in each group by learning the correction vectors.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating non-limiting exemplary architecture of one system in accordance with some embodiments of the present invention;

FIG. 2 is a high-level flowchart illustrating non-limiting exemplary method in accordance with embodiments of the present invention; and

FIG. 3 is an exemplary diagram illustrating the clustered readings and the corrections vectors used for training in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing” “computing”, “calculating”, “determining” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

The automotive marketplace in accordance with embodiments of the present invention receives large amounts of road-sign data that is inaccurate and noisy. These are the steps needed to be able to “fix” the location data and generate an accurate output with road-sign locations:
A. Create a machine learning model that would “repair” all individual data items.
B. Filter out the raw data by location to match the area where our reference data exists.
C. Use a clustering algorithm to isolate reports about a single sign (by the signs location and the sign metadata)
D. Compare the resulting signs' locations and type to the reference signs in our external road-signs dataset. Train a machine learning model to “fix” raw data items using the metadata of the raw data.
E. Run the newly created machine learning model on the raw data and repeat stages B and C until the resulting machine model stops improving (gradient descent style).
F. Using the newly created machine model, “fix” the entire raw dataset.
G. Run the same clustering method to produce the location of signs from all over the raw dataset.

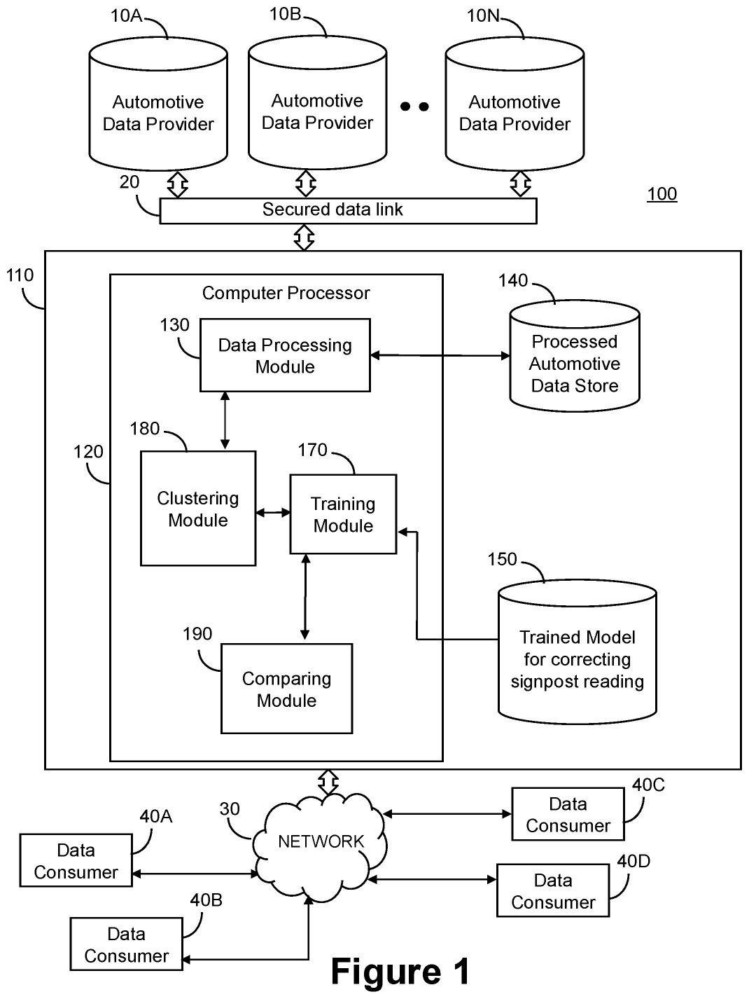

FIG. 1 is a block diagram illustrating non-limiting exemplary architecture of the system in accordance with some embodiments of the present invention. Automotive data marketplace 100 comprises at least one automotive data server 110 which may, in preferable embodiments, be a secured automotive data server fully compliant with data protection and privacy regulations.

Server 110 may be implementing a data marketplace and connected via network 30 to a plurality of data consumers 40A-40D. Vehicle related data, possibly obtained from various sensors may be stored in raw format on a plurality of vehicle related data sources such as automotive data providers 10A-10N and are accessed by server 110 via a secured data link 20. Server 110 may include a data processing module 130 implemented by a computer readable code running on computer processor 120 that stores processed automotive data records on data store 140.

In accordance with some embodiments of the present invention, a system for generating a machine learning model for reducing a location error of readings of road signs sensed by connected vehicle may be implemented on automotive data marketplace 100. A data processing module 130 may be configured to obtain an incoming stream of readings of road signs captured by connected vehicles traveling along roads, e.g., from processed automotive data store 140, wherein each reading contains a location of a road sign and road sign metadata associated therewith.

In accordance with some embodiments of the present invention, a clustering module 180 may be configured to use a clustering algorithm to group together readings associated with a common road sign in clusters.

In accordance with some embodiments of the present invention, a comparing module 190 may be configured to compare the locations of each cluster to respective tagged road-signs dataset associated with a correct location, to yield a respective correction vector for each cluster.

In accordance with some embodiments of the present invention, a training module 170 may be configured to train a machine learning model to correct the location of the readings in each group by learning the correction vectors.

In accordance with some embodiments of the present invention, a trained machine learning model 150 may be used to repair the entire raw dataset by applying it via training module 170.

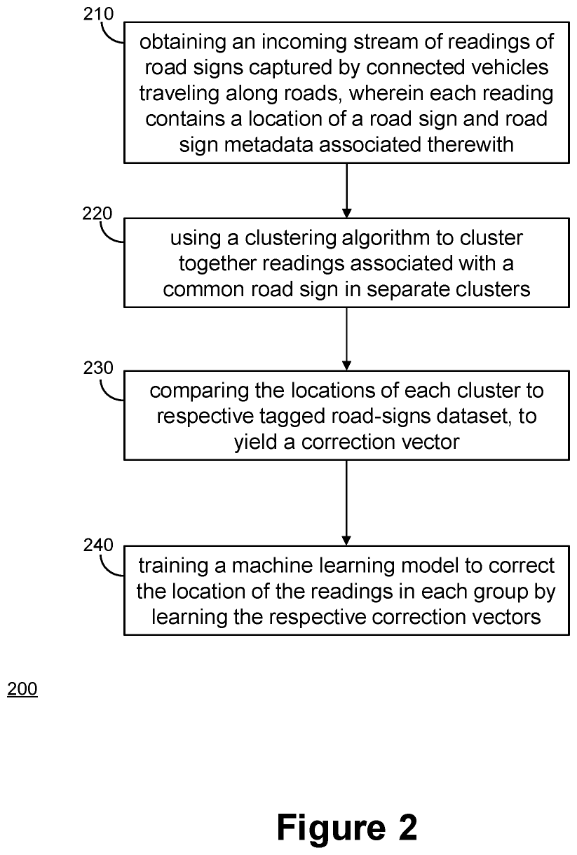

FIG. 2 is a high-level flowchart illustrating non-limiting exemplary method in accordance with embodiments of the present invention. A method 200 of A method and a system for generating a machine learning model for reducing an error of readings of road signs sensed by connected vehicles, said method comprising: obtaining an incoming stream of readings of road signs captured by connected vehicles traveling along roads, wherein each reading contains a location of a road sign and road sign metadata associated therewith 210; using a clustering algorithm to group together readings associated with a common road sign in separate groups 220; comparing the locations of each group to respective tagged road-signs dataset, to yield a correction vector 230; and training a machine learning model to correct the location of the readings in each group by learning the respective correction vectors 240.

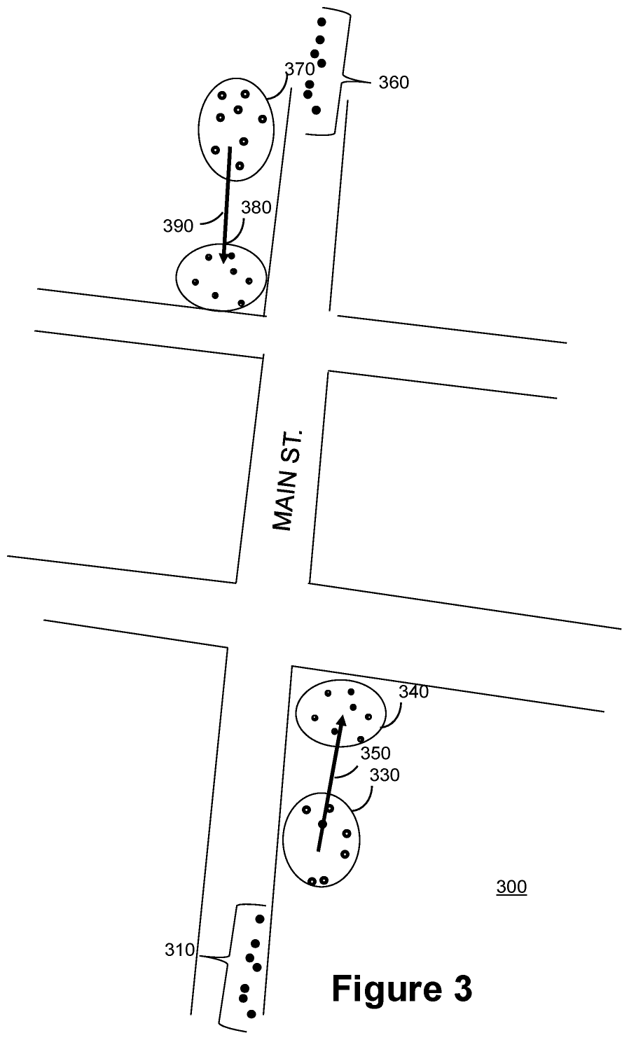

FIG. 3 is an exemplary diagram illustrating the clustered readings and the corrections vectors used for training in accordance with embodiments of the present invention on a roadmap 300. Vehicles positions (e.g., GPS) 310 and 360 are collected and each such reading is associated with its respective road sign reading shown collectively in clusters 330 and 370 respectively. These readings are what the vehicle sensors are capable of provide as measures location (usually relative distance) from the road sign itself (not shown). These readings are clusters per common road sign. Then each of the readings in clusters 330 and 370 are compared with tagged data set that includes correct and validated position of the respective road sign, so as to provide corrected locations in clusters 340 and 380 respectively, thus producing correction vectors 350 and 380 respectively.

As explained above, these correction vectors are fed into a training module which generates a machine learning model capable of fixing the location error of the vehicle-obtained readings for the road signs. As can be shown, a major error may be caused by the drift in the sensors reading along the direction of the rise of the vehicles, but other errors occur and their pattern is studied by the machine learning algorithm so that a meaningful fix may be applied to the entire dataset of reading thus significantly improving the accuracy of automotive data as a source for road signs mapping.

In order to implement method and system according to embodiments of the present invention, a computer processor may receive instructions and data from a read-only memory or a random-access memory or both. At least one of aforementioned steps may be performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++, Python or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures, and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting of” and grammatical variants thereof do not preclude the addition of one or more components, features, steps, or integers or groups thereof and that the terms are to be construed as specifying components, features, steps, or integers.

If the specification or claims refer to “an additional” element, that does not preclude there being more than one of the additional elements.

It is to be understood that where the claims or specification refer to “a” or “an” element, such reference is not construed that there is only one of that elements.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation, or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of generating a machine learning model for reducing a location error of readings of road signs sensed by connected vehicle, said method comprising:
obtaining an incoming stream of readings of road signs captured by connected vehicles traveling along roads, wherein each reading contains a location of a road sign and road sign metadata associated therewith;
using a clustering algorithm to group together readings associated with a common road sign into clusters;
comparing the locations of the readings in each cluster to respective tagged road-signs dataset associated with a correct location of the road sign associated with the cluster, to yield a correction vector; and
training a machine learning model to correct the location of the readings in each group by learning the correction vector.

2. The method according to claim 1, further comprising running the machine learning model on the training dataset of readings.

3. The method according to claim 1, further comprising repeating: the clustering, the comparing, and the training until the machine learning model stops improving.

4. The method according to claim 1, further comprising using the trained machine learning model to repair the entire raw dataset.

5. The method according to claim 1, further comprising running the same clustering method to produce the location of signs from all over the raw dataset.

6. A system for generating a machine learning model for reducing a location error of readings of road signs sensed by connected vehicle, said system comprising:
a data processing module configured to obtain an incoming stream of readings of road signs captured by connected vehicles traveling along roads, wherein each reading contains a location of a road sign and road sign metadata associated therewith;
a clustering module configured to use a clustering algorithm to group together readings associated with a common road sign in clusters;
a comparing module configured to compare the locations of each cluster to respective tagged road-signs dataset associated with a correct location, to yield a correction vector; and
a training module configured to train a machine learning model to correct the location of the readings in each group by learning the correction vectors.

7. The system according to claim 6, further comprising running the machine learning model on the training dataset of readings.

8. The system according to claim 6, further comprising repeating: the clustering, the comparing, and the training until the machine learning model stops improving.

9. The system according to claim 6, further comprising using the trained machine learning model to repair the entire raw dataset.

10. The system according to claim 6, further comprising running the same clustering method to produce the location of signs from all over the raw dataset.

11. A non-transitory computer readable medium for generating a machine learning model for reducing a location error of readings of road signs sensed by connected vehicles, the computer readable medium comprising a set of instructions that when executed cause at least one computer processor to:
obtain an incoming stream of readings of road signs captured by connected vehicles traveling along roads, wherein each reading contains a location of a road sign and road sign metadata associated therewith;
apply a clustering algorithm to group together readings associated with a common road sign into groups;
compare the locations of each cluster to respective tagged road-signs dataset associated with a correct location of the road sign associated with the group, to yield a correction vector; and
train a machine learning model to correct the location of the readings in each cluster by learning the correction vectors.

12. The non-transitory computer readable medium according to claim 11, further comprising a set of instructions that when executed cause the at least one computer processor to run the machine learning model on the training dataset of readings.

13. The non-transitory computer readable medium according to claim 11, further comprising a set of instructions that when executed cause the at least one computer processor to repeat the clustering, the comparing, and the training until the machine learning model stops improving.

14. The non-transitory computer readable medium according to claim 11, further comprising a set of instructions that when executed cause the at least one computer processor to use the trained machine learning model to repair the entire raw dataset.

15. The non-transitory computer readable medium according to claim 11, further comprising a set of instructions that when executed cause the at least one computer processor to run the same clustering method to produce the location of signs from all over the raw dataset.
